(19) United States
(12) Patent Application Publication
(10) Pub. No.: US 2019/0393641 A1
(43) Pub. Date: Dec. 26, 2019

(54) WATERPROOF PLUG INSERTION DEVICE AND CONNECTOR HOUSING MANUFACTURING METHOD WITH WATERPROOF PLUG

(71) Applicant: Yazaki Corporation, Tokyo (JP)

(72) Inventors: Yusuke MACHIDA, Makinohara-shi (JP); Kazuhiko Takada, Makinohara-shi (JP)

(73) Assignee: Yazaki Corporation, Tokyo (JP)

(21) Appl. No.: 16/376,041

(22) Filed: Apr. 5, 2019

(30) Foreign Application Priority Data
Jun. 25, 2018 (JP) 2018-119871

(51) Int. Cl. H01R 13/52

(52) U.S. Cl. CPC H01R 13/52

(57) ABSTRACT

In the XY plane, the pin member 4 and the exit aperture 2A are interlocked, and the template 7 has a pin hole 71 at a position corresponding to the target receiving chamber. Thereby, when the pin member 4 and the pin hole 71 are fitted together, the exit aperture 2A is aligned with the target receiving chamber. Therefore, the worker can insert the waterproof plug into the target receiving chamber by causing emitting device 2 to emit the waterproof plug in a state where the pin member 4 and the pin hole 71 are fitted. In this way, when inserting the waterproof plug into the terminal receiving chamber of the connector housing 100, the operator does not need to align the exit aperture 2A with the terminal receiving chamber, thereby workability can improved.

### TECHNICAL FIELD

The present invention relates to a waterproof plug insertion device for inserting a waterproof plug into a terminal receiving chamber of a connector housing and a method for manufacturing a connector housing with a waterproof plug.

### BACKGROUND ART

In general, a plurality of terminal receiving chambers is formed in the connector housing, but terminals may not be received in some of the terminal receiving chambers in some cases. In the waterproof connector, when there is an empty receiving chamber that does not receive the terminal, water may pass through the empty receiving chamber and the waterproof property may not be ensured. Therefore, a waterproof plug pushing device for inserting a waterproof plug into a cavity (terminal receiving chamber) of a connector has been proposed (see, for example, Patent Literature 1). In the waterproof plug pushing device described in Patent Literature 1, by providing a pressurizing mechanism for pushing out the waterproof plug, the workability when mounting the waterproof plug in the cavity is improved.

### PRIOR ART DOCUMENT

### Patent Literature

Patent Literature 1: JP 2002-324620 A

### SUMMARY OF INVENTION

### Technical Problem

However, in the waterproof plug pushing device described in Patent Literature 1, an operator must select a cavity to which the waterproof plug is to be attached and align the tip of the device with respect to this cavity. Therefore, further improvement in workability has been desired.

An object of the present invention is to provide a waterproof plug insertion device and a method for manufacturing a connector housing with a waterproof plug, which can improve workability when a waterproof plug is inserted into a terminal receiving chamber of a connector housing.

### Solution to Problem

According to the present invention, there is provided a waterproof plug insertion device for inserting a waterproof plug into a target receiving chamber of a plurality of terminal receiving chambers in a connector housing, the waterproof plug insertion device comprising:

an emitting device for emitting the waterproof plug from an exit aperture;

a supply device for supplying the waterproof plug to the emitting device;

a fitting portion interlocking with the exit aperture in an intersecting plane intersecting an emitting direction of the waterproof plug;

an operation unit for moving the emitting device and the fitting portion;

a holding base for holding the connector housing; and

a positioning unit provided on the holding base,

wherein the positioning unit has a fitted portion that can be fitted with the fitting portion at a position corresponding to the target housing chamber.

### Effect of the Invention

According to the waterproof plug insertion device of the present invention, the fitting portion and the exit aperture are interlocked within the plane intersecting the emitting direction, and the positioning unit has the fitted portion at a position corresponding to the object receiving chamber. Thereby, when the fitting portion and the fitted portion are fitted together, the exit aperture is aligned with the target receiving chamber. Therefore, the operator can insert the waterproof plug into the target receiving chamber by causing the emitting device to emit the waterproof plug in a state where the fitting portion and the fitted portion are fitted together. In this way, when inserting the waterproof plug into the terminal receiving chamber of the connector housing, the operator does not need to align the exit aperture with the terminal receiving chamber, so that workability can be improved.

### BRIEF DESCRIPTION OF DRAWINGS

FIG. 1 is a perspective view showing a waterproof plug insertion device according to an embodiment of the present invention;

FIG. 2 is a perspective view showing a main part of the waterproof plug insertion device;

FIG. 3 is a perspective view showing another main part of the waterproof plug insertion device;

FIG. 4 is a plan view showing a terminal receiving chamber of a connector housing held by the waterproof plug insertion device; and

FIG. 5 is a plan view showing a relationship between the terminal receiving chamber and a fitted portion of the waterproof plug insertion device.

### DESCRIPTION OF EMBODIMENTS

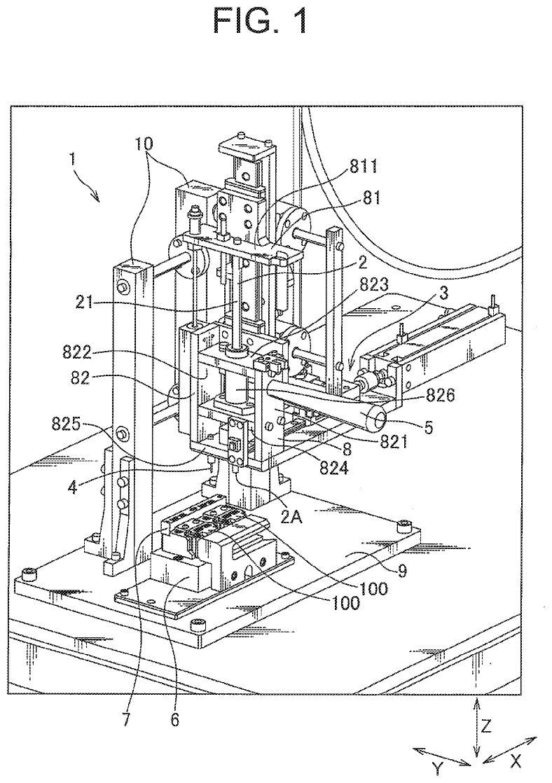

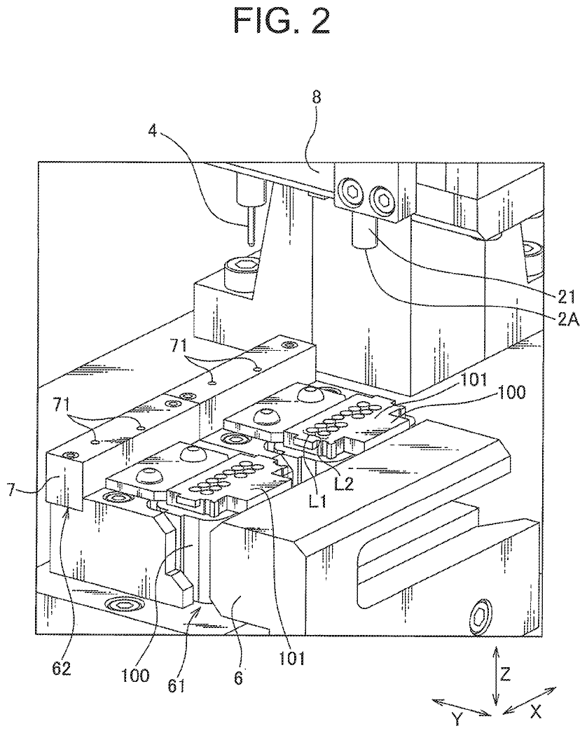

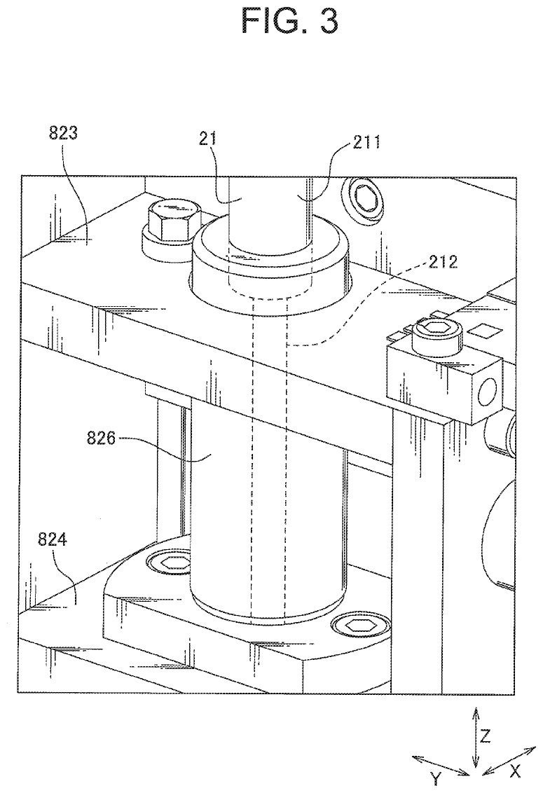

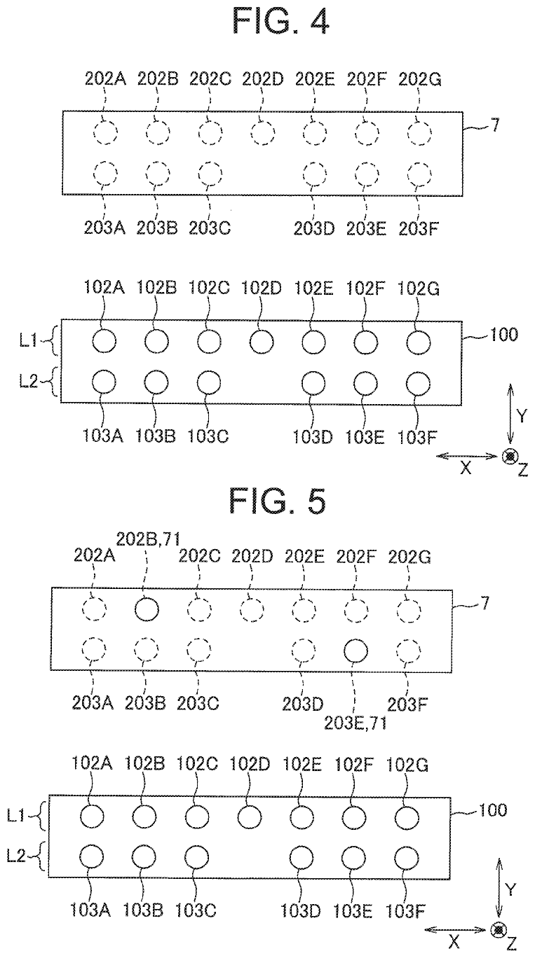

Hereinafter, embodiments of the present invention will be described with reference to the drawings. FIG. 1 is a perspective view showing a waterproof plug insertion device 1 according to an embodiment of the present invention. FIG. 2 is a perspective view showing a main part of the waterproof plug insertion device 1. FIG. 3 is a perspective view showing another main part of the waterproof plug insertion device 1. FIG. 4 is a plan view showing a terminal receiving chamber of a connector housing 100 held by the waterproof plug insertion device 1. FIG. 5 is a plan view showing a relationship between the terminal receiving chamber and a pin hole 71 of the waterproof plug insertion device 1.

As shown in FIG. 1, the waterproof plug insertion device 1 of the present embodiment is for inserting a waterproof plug into a terminal receiving chamber of the connector housing 100, and includes an emitting device 2, a supply device 3, a pin member 4, an operation unit 5, a holding base 6, a template 7 as a positioning unit, and a connecting device 8. The connector housing 100 constitutes, for example, a waterproof connector for connecting a battery mounted on a vehicle and an electrical component. In the present embodiment, an insertion direction (emitting direction) of the waterproof plug is Z direction, and the two directions substantially orthogonal to the Z direction are X direction and Y direction. Further, the waterproof plug insertion device 1 is used so that the Z direction substantially coincides with the vertical direction and an XY plane substantially coincides with the horizontal plane.

As shown in FIGS. 2 and 3, the emitting device 2 has a cylindrical nozzle member 21 fixed to an upper plate 811 of the connecting device 8 to be described later and extending along the Z direction. The nozzle member 21 is constituted by an upper large diameter portion 211 and a lower small diameter portion 212, and an opening at the lower end of the small diameter portion 212 is an exit aperture 2A. The small diameter portion 212 can be attached to and detached from the large diameter portion 211, and for example, when the small diameter portion 212 is damaged, only the small diameter portion 212 can be exchanged. By pressurizing an inside of the nozzle member 21 with a compressor, the waterproof plug is emitted from the exit aperture 2A.

The supply device 3 supplies a waterproof plug to the upper part of the nozzle member 21 of the emitting device 2. In the present embodiment, a plurality of waterproof plugs is connected in series to form a continuous body, and this continuous body is received in a tube communicating with the nozzle member 21. The supply means 3 cuts the continuous body into one waterproof plug and pressurizes the interior of the tube with a compressor so that the waterproof plug is supplied into the nozzle member 21. Incidentally, the compressor for emitting the waterproof plug from the exit aperture 2A and the compressor for supplying the waterproof plug to the emitting device 2 may be common or may be independent from each other.

The pin member 4 is fixed to a later-described lower plate 825 of the connecting device 8 and projects from the lower surface of the lower plate 825 and extends along the Z direction. The pin member 4 is connected to the nozzle member 21 of the emitting device 2 by the connecting device 8, thereby configured to move integrally with the nozzle member 21 in the XY plane. In other words, the pin member 4 and the exit aperture 2A move in conjunction with each other on the XY plane.

The operation unit 5 is a bar-shaped handle fixed to a later-described side plate 821 of the connecting device 8 and extending along the Y direction. When the operator operates the operation unit 5, the lower unit 82, which will be described later, of the connection device 8 moves three-dimensionally in parallel.

The holding base 6 is placed on a plate-like base 9, and has a housing holding portion 61 for holding the connector housing 100 and a disposing portion 62 on which the template 7 is disposed. Since the housing holding portion 61 and the disposing portion 62 are aligned in the Y direction, the held connector housing 100 and the template 7 are aligned in the Y direction.

The housing holding portion 61 holds the two connector housings 100 by sandwiching the two connector housings 100 from the Y direction while aligning the two connector housings 100 in the X direction. In the connector housing 100 held by the housing holding portion 61, a plurality of terminal receiving chamber forming surfaces 101 is directed upward in the Z direction (toward the connecting device 8). In addition, the connector housing 100 has two rows of receiving chamber rows L 1, L 2 in which the terminal receiving chambers are arranged. When being held by the housing holding portion 61, the receiving chamber rows L1 and L2 extend along the X direction, respectively, and the receiving chamber rows L1 and L2 are aligned in the Y direction. The connector housing 100 has a rectangular shape when viewed from the Z direction, and the connector housing 100 is held such that a long side direction substantially coincides with the X direction and a short side direction substantially coincides with the Y direction.

The template 7 is a metal member formed in a band plate shape whose longitudinal direction is the X direction. In this embodiment, the same number (namely, two) of templates 7 as the connector housings 100 held by the housing holding portion are arranged in the disposing portion 62. Incidentally, one template may be provided corresponding to the plurality of connector housings 100, or a plurality of templates may correspond to one connector housing 100.

The template 7 has fixing portions at both ends in the X direction, so that the template 7 is fixed to the holding base 6 with bolts or the like. That is, the template 7 is formed separately from the holding base 6 and is detachable from the holding base 6. A pin hole 71 into which the pin member 4 is inserted is formed on an upper surface of the template 7. This pin hole 71 functions as a fitted portion to be fitted with the pin member 4 as a fitting portion.

The connecting device 8 includes an upper unit 81 and a lower unit 82 which are capable of moving toward and away from each other in the Z direction and interlocked within the XY plane. The connecting device 8 is supported by two support posts 10 standing from the base 9 and extending along the Z direction. The upper unit 81 has an upper plate 811 extending along the XY plane.

The lower unit 82 includes: a pair of side plates 821, 822 extending along the ZX plane and spaced apart in the Y direction; a pair of intermediate plates 823, 824 extending along the XY plane and spaced apart in the Z direction; and a lower plate 825 extending along the XY plane and disposed below the intermediate plates 823, 824. The pair of intermediate plates 823, 824 and the lower plate 825 are sandwiched by the pair of side plates 821, 822.

A guide cylinder 826 extending along the Z direction is provided between the pair of intermediate plates 823, 824. The nozzle member 21 is inserted through the guide cylinder 826 and the large diameter portion 211 is guided by the guide cylinder 826 so that the nozzle member 21 moves along the Z direction.

Since the operation unit 5 is fixed to the lower unit 82, and the upper unit 81 and the lower unit 82 are interlocked in the XY plane, when the operator operates the operation unit 5 to move the connecting device 8 within the XY plane, both the upper unit 81 and the lower unit 82 move. That is, the nozzle member 21 fixed to the upper unit 81 and the pin member 4 fixed to the lower unit 82 are interlocked in the XY plane. At this time, in the XY plane, the moving distance of the operating unit 5, the moving distance of the pin member 4, and the moving distance of the nozzle member 21 are equal to each other.

Since the operation unit 5 is fixed to the lower unit 82, and the upper unit 81 and the lower unit 82 can be attached to and detached from each other in the Z direction, when the operator operates the operation unit 5 to move the connecting unit 8 in the Z Direction, only the lower unit 82 moves. That is, the nozzle member 21 fixed to the upper unit 81 and the pin member 4 fixed to the lower unit 82 are not interlocked with each other in the Z direction. The waterproof plug insertion device 1 is equipped with a driving device for moving the upper unit 81 in the Z direction. When the operator performs a predetermined operation (for example, stepping on a pedal), the upper unit 81 moves in the Z direction, and accordingly the nozzle member 21 also moves in the Z direction.

Here, details of the pin hole 71 formed in the template 7 will be described with reference to FIGS. 4 and 5. In the present embodiment, the receiving chamber row L1 of the connector housing 100 is constituted by seven terminal receiving chambers 102A to 102G, and the receiving chamber row L2 is constituted by six terminal receiving chambers 103A to 103F. The three terminal receiving chambers 103A to 103C and the three terminal receiving chambers 103D to 103F are spaced apart by one terminal receiving chamber.

The terminal receiving chambers 102A to 102G constituting the receiving chamber row L1 are moved in parallel in the Y direction by a predetermined distance as virtual receiving chambers 202A to 202G, and the terminal receiving chambers 103A to 103F constituting the receiving chamber row L2 are moved in parallel in the Y direction by the same predetermined distance as virtual receiving chambers 203A to 203F. The pin hole 71 formed in the template 7 is formed at a position overlapping with any of the virtual receiving chambers 202A to 202G, 203A to 203F. That is, the pin hole 71 is arranged at a position overlapping with the virtual receiving chambers 202A to 202G, 203A to 203F in which the plurality of terminal receiving chambers 102A to 102G, 103A to 103F are translated in parallel in the XY plane in a state where the connector housing 100 is held by the holding base 6.

In the example shown in FIG. 5, in the template 7, pin holes 71 are formed at positions overlapping the virtual receiving chambers 202B and 203E, respectively. That is, among the plurality of terminal receiving chambers 102A to 102G, 103A to 103F, the terminal receiving chambers 102B and 103E become target receiving chambers, and the waterproof plugs are inserted. Incidentally, the positions and the number of the pin holes formed in the template 7 may be appropriately set according to which terminal receiving chamber becomes the target receiving chamber.

In the waterproof plug insertion device 1 as described above, the operator performs an operation according to the following procedure, whereby the waterproof plug is inserted into the target receiving chamber of the connector housing 100 (that is, the connector housing with the waterproof plug is manufactured). First, the operator holds the connector housing 100 on the holding base 6. Incidentally, when the target receiving chamber is changed, the template 7 may be exchanged. Next, the operator aligns the pin member 4 with the pin hole 71 in the XY plane by operating the operation unit 5 (operation process). At this time, when the tip of the pin member 4 is far from the pin hole 71 in the Z direction, the pin member 4 may be brought close to the pin hole 71.

When the pin member 4 and the pin hole 71 are aligned with each other, the operator lowers the operation unit 5 to lower the pin member 4 and insert the pin member 4 into the pin hole 71. As a result, the exit aperture 2A is aligned with the target receiving chamber. Next, the operator lowers the nozzle member 21 by the driving device and brings it close to the terminal receiving chamber (target receiving chamber). At this time, the exit aperture 2A may contact the connector housing 100 or may not contact the connector housing 100. Next, the operator causes the waterproof plug to be emitted from the exit aperture 2A by the compressor (emission step), and to be inserted into the terminal receiving chamber. Incidentally, the operation for lowering the nozzle member 21 and the operation for emitting the waterproof plug may be independent, or may be one operation.

In a case where a plurality of target receiving chambers are set in the connector housing 100, after the waterproof plug is inserted, the pin member 4 and the nozzle member 21 are raised, and then by repeating the above operation, the waterproof plugs are inserted into all the target receiving chambers.

According to the embodiment described above, there is the following effect. That is, in the XY plane, the pin member 4 and the exit aperture 2A move together, and the template 7 has the pin hole 71 at a position corresponding to the target receiving chamber. Therefore, when the pin member 4 and the pin hole 71 are fitted together, the exit aperture 2A is aligned with the target receiving chamber. Accordingly, the operator can insert the waterproof plug into the target receiving chamber by causing the emitting device 2 to emit the waterproof plug the in a state where the pin member 4 and the pin hole 71 are fitted together. In this way, when inserting the waterproof plug into the terminal receiving chamber of the connector housing 100, the operator does not need to align the exit aperture 2A with the terminal receiving chamber, so that workability can be improved.

In addition, since the template 7 has the pin hole 71 at the position corresponding to the target receiving chamber, the operator does not need to select the target receiving chamber from the plurality of terminal receiving chambers. Therefore, it is possible to suppress the erroneous insertion of the waterproof plug into the terminal receiving chamber to receive a terminal fitting.

Further, since the pin hole 71 is disposed at a position overlapping the virtual receiving chamber, it is possible to easily manufacture the template 7 according to the target receiving chamber. Further, the operator can easily confirm which terminal receiving chamber is set as the target receiving chamber based on an arrangement of the pin hole 71.

Further, since the template 7 is attachable to and detachable from the holding base 6, it is possible to cope with by changing the template 7 when the terminal receiving chamber as the target receiving chamber is changed.

In addition, since the connector housing 100 and the template 7 are arranged in the Y direction which is the short side direction of the connector housing 100, the pin member 4 and the exit aperture 2A can be disposed close to each other, and it is easy to view the pin member 4 and the exit aperture 2A at the same time, so that workability can be improved.

Incidentally, the present invention is not limited to the above-described embodiment, but includes other configurations and the like that can achieve the object of the present invention, and the following modifications and the like are also included in the present invention.

For example, in the above embodiment, the connector housing 100 and the template 7 are arranged in the Y direction which is the short side direction of the connector housing 100. However, the connector housing 100 and the template 7 may be arranged in other directions (for example, the X direction which is the long side direction of the connector housing 100), and the arrangement of the connector housing 100 may be set appropriately according to space efficiency, workability, and the like.

Further, in the above-described embodiment, the template 7 as the positioning unit is formed separately from the holding base 6 and is attachable and detachable. However, the positioning unit may be fixed to the holding base and may not be attachable and detachable. Further, the positioning unit may be formed integrally with the holding base. That is, the fitted portion such as a pin hole may be formed on the holding base, and a region where the fitted portion is formed may be used as the positioning unit.

Further, by covering the template having the pin holes formed therein with a cover member, the pin member can be inserted into only the predetermined pin hole. That is, a pin hole may be formed in all the positions of the template overlapping with the virtual receiving chamber, and a cover member may be used which opens the pin hole corresponding to the target receiving chamber and covers the other pin holes.

Further, in the above-described embodiment, the pin member 4 functions as a fitting portion and the pin hole 71 functions as a fitted portion, that is, the fitting portion is a convex portion and the fitted portion is a concave portion. However, the fitting portion may be a concave portion and the fitted portion may be a convex portion. Further, the shapes of the fitting portion and the fitted portion are not limited to concavity and convexity, and may be any shape as long as the operator can recognize that they are fitted with each other.

In the above embodiment, the operating unit 5, the pin member 4, and the nozzle member 21 are connected by the connecting device 8, and in the XY plane, the moving distance of the operating unit 5, the moving distance of the pin member 4, and the moving distance of the nozzle member 21 are equal to each other. However, the moving distance of the pin member 4 and the nozzle member 21 may be different from each other, and may be different from the moving distance of the operating unit 5. For example, in the case where the space between the terminal receiving chambers in the housing 100 is narrow, the moving distance of the pin member 4 may be obtained by multiplying the moving distance of the nozzle member 21 by a predetermined coefficient (1 or more). In this case, the pin hole 71 is not disposed at a position overlapping with the virtual receiving chamber.

Although the best configurations, methods, and the like for carrying out the present invention are disclosed in the above description, the present invention is not limited thereto. While the invention has been particularly shown and described with particular reference to certain embodiments thereof, material, quantity, and other detailed configurations, various modifications can be made by those skilled in the art without departing from the spirit and scope of the invention. Accordingly, the description that limits the shape, material, etc. disclosed above is exemplarily described for easy understanding of the present invention, and does not limit the present invention, so the description of the parts with limitations on part or all of the restrictions on their shapes, materials and the like is included in the present invention.

### REFERENCE SIGNS LIST

| | |
|---|---|
| 1 | waterproof plug insertion device |
| 2 | emitting device |
| 2A | exit aperture |
| 3 | supply device |
| 4 | pin member (fitting portion) |
| 5 | operation unit |
| 6 | holding base |
| 7 | template (positioning unit) |
| 71 | pin hole (fitted portion) |
| 100 | connector housing |
| 102A-102G, 103A-103F | terminal receiving chamber |
| 202A-202G, 203A-203F | virtual receiving chamber |

1. A waterproof plug insertion device for inserting a waterproof plug into a target receiving chamber of a plurality of terminal receiving chambers in a connector housing, the waterproof plug insertion device comprising:
an emitting device for emitting the waterproof plug from an exit aperture;
a supply device for supplying the waterproof plug to the emitting device;
a fitting portion interlocking with the exit aperture in an intersecting plane intersecting an emitting direction of the waterproof plug;
an operation unit for moving the emitting device and the fitting portion;
a holding base for holding the connector housing; and
a positioning unit provided on the holding base,
wherein the positioning unit has a fitted portion that can be fitted with the fitting portion at a position corresponding to the target housing chamber.

2. The waterproof plug insertion device as claimed in claim 1,
wherein the fitted portion is disposed at a position overlapping a virtual receiving chamber in which the plurality of terminal receiving chambers is moved in parallel in the intersecting plane in a state where the connector housing is held by the holding base.

3. The waterproof plug insertion device as claimed in claim 1,
wherein the positioning unit is formed separately from the holding base and is detachable.

4. The waterproof plug insertion device as claimed in claim 2,
wherein the positioning unit is formed separately from the holding base and is detachable.

5. The waterproof plug insertion device as claimed in claim 1,
wherein the holding base holds the connector housing so as to be aligned with the positioning unit in a short side direction of the connector housing.

6. The waterproof plug insertion device as claimed in claim 2,
wherein the holding base holds the connector housing so as to be aligned with the positioning unit in a short side direction of the connector housing.

7. The waterproof plug insertion device as claimed in claim 3,
wherein the holding base holds the connector housing so as to be aligned with the positioning unit in a short side direction of the connector housing.

8. A producing method of a connector housing with a waterproof plug for producing the connector housing in which the waterproof plug is inserted into a target receiving chamber among a plurality of terminal receiving chambers in the connector housing, the method comprising the steps of:
interlocking a fitting portion with an exit aperture in an intersecting plane intersecting an emitting direction of the waterproof plug;
emitting the waterproof plug from the exit aperture while the fitting portion and a fitted portion are fitted to each other, the fitted portion being provided on a holding base for holding the connector housing and being disposed at a position corresponding to the target receiving chamber.
